(19) United States
(12) Patent Application Publication
(10) Pub. No.: US 2025/0153501 A1
(43) Pub. Date: May 15, 2025

(54) Foldable Clipboard

(71) Applicant: Muhammad Sarfraz Khaliq, Brea, CA (US)

(72) Inventor: Muhammad Sarfraz Khaliq, Brea, CA (US)

(21) Appl. No.: 18/635,001

(22) Filed: Apr. 15, 2024

Related U.S. Application Data
(63) Continuation-in-part of application No. 18/389,576, filed on Nov. 14, 2023.

(51) Int. Cl. B42F 9/00

(52) U.S. Cl. CPC B42F 9/001

(57) ABSTRACT

According to an aspect of the present invention, there is provided a foldable clipboard including a three panel foldable clipboard in which three panels cooperate to form a single planar surface when in an extended position, and at least two panels of the three panels are configured to pivotally move to overlap each other in a folded position, such that a full sized clipboard is folded into a size to fit in a pocket of a garment.

### CROSS-REFERENCE

The present invention hereby incorporates U.S. Pat. No. 11,685,182 by reference in its entirety.

### SUMMARY

A foldable clipboard has been described by the present inventor in U.S. Pat. No. 11,685,182.

The present disclosure introduces a different position of the hinges on the foldable clipboard.

According to an aspect of the present disclosure, there is provided a foldable clipboard, comprising: a first folding panel, a second panel, and a third folding panel configured to form a single planar surface when positioned in an expanded position, such that a second edge of the first folding panel abuts a first edge of the second panel and a second edge of the second panel abuts a first edge of the third folding panel; a first pair of hinges; and a second pair of hinges, wherein: each hinge of the first pair of hinges and the second pair of hinges includes an outer leg bracket and an inner leg bracket that are pivotally connected together; the outer leg brackets and the inner leg brackets are configured to rotate towards the front surface of the foldable clipboard; and wherein when the foldable clipboard is moved into a folded position, the inner side of each outer bracket of both the first pair of hinges and the second pair of hinges moves over at least a portion of each inner side of each inner leg bracket of both the first pair of hinges and the second pair of hinges.

### BRIEF DESCRIPTION OF THE DRAWINGS

The structure, operation, and advantages of the present invention will become further apparent upon consideration of the following description taken in conjunction with the accompanying figures. The figures are intended to be illustrative, and not limiting.

FIG. 1 is an front view of the foldable clipboard in an open position, according to the present invention.

FIG. 2 is a back view of a partially folded position of the foldable clipboard of FIG. 1;

FIG. 3 is a left side view of a completely unfolded position of the foldable clipboard of FIG. 1;

FIG. 4 is a right side view of a completely unfolded position of the foldable clipboard of FIG. 1;

FIG. 5 is a top view of the foldable clipboard of FIG. 1;

FIG. 6 is a bottom view of the foldable clipboard of FIG. 1;

FIG. 7 is a perspective view of the foldable clipboard of FIG. 1;

FIG. 8 is another perspective view of the foldable clipboard of FIG. 1;

FIG. 9 is a partially folded view of the foldable clipboard of FIG. 1;

FIG. 10 is another perspective view of the foldable clipboard of FIG. 1;

FIG. 11 is completely folded top view of the foldable clipboard of FIG. 1; and

FIG. 12 is a completely folded bottom view of the foldable clipboard of FIG. 1.

### DETAILED DESCRIPTION

In the description that follows, numerous details are outlined to provide a thorough understanding of the present invention. It will be appreciated by those skilled in the art that variations of these specific details are possible while still achieving the results of the present invention.

Exemplary illustrative embodiments of the invention should be interpreted as example(s) and non-limiting. The relationship between various components, where they are located, their composition(s), their operation and sometimes their sizes relative to the desired operation of the invention are significant.

The foldable clipboard is designed as an improvement to a traditional flat, rigid clipboard and other known clipboards. It is designated as a “mini” foldable clipboard because it can be folded to a size which is reasonable to place, for example, but not by way of limitation, in a suit jacket pocket, a laboratory coat pocket, a standard coat pocket, a pants pocket, a purse, and the like. The foldable clipboard is of particular use to doctors and medical personnel because the foldable clipboard can be folded in three layers to comfortably fit into a medical coat pocket, a scrubs pocket, and even a jeans pocket. For example, the foldable clipboard may be utilized to secure patient assessment forms, nursing protocols, medication lists, and all documentation in a HIPAA compliant secure foldable clipboard. However, it is within the terms of the embodiment that the foldable clipboard may also be used to accommodate the needs of a variety of different people in a variety of services or work environments, as described in non-limiting examples herein.

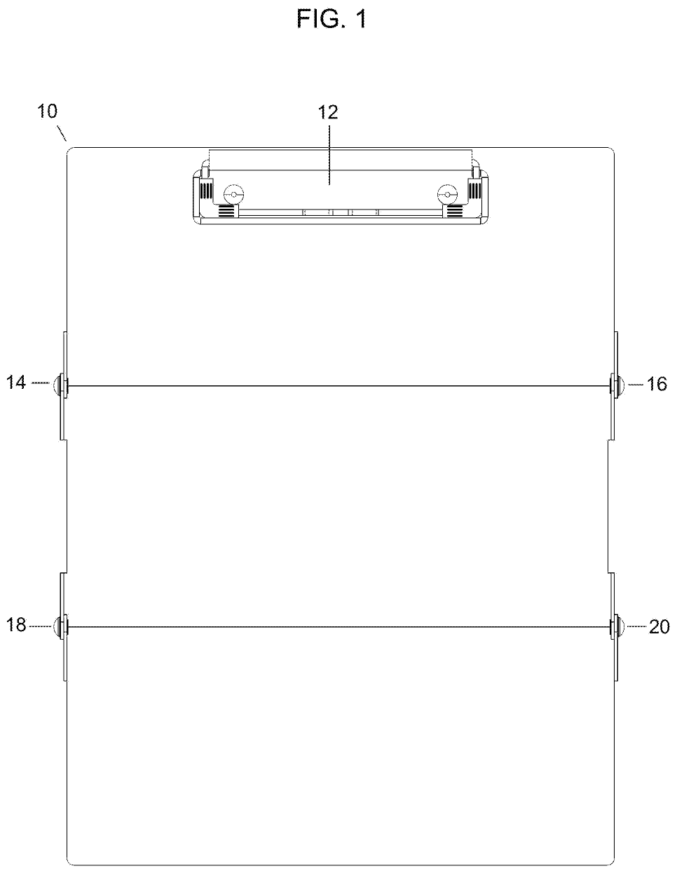

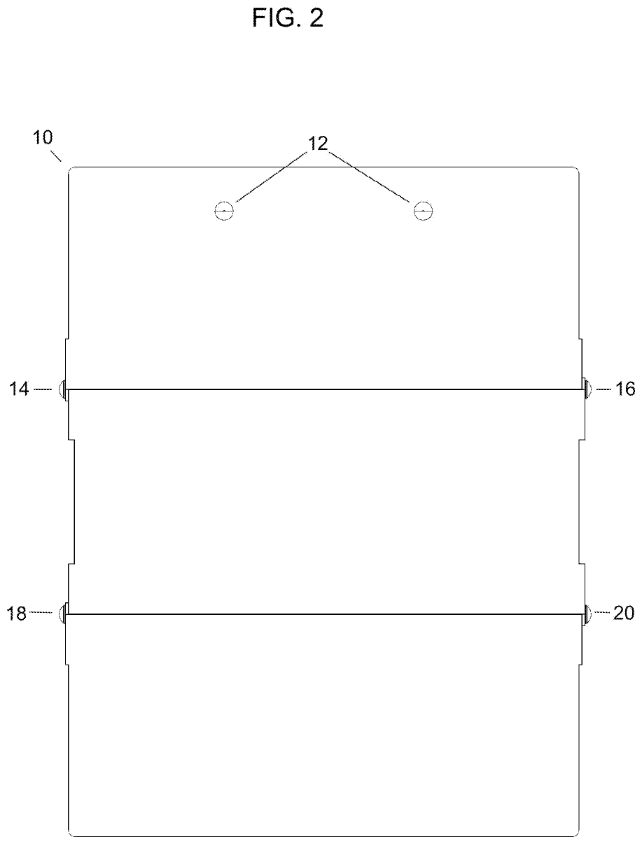

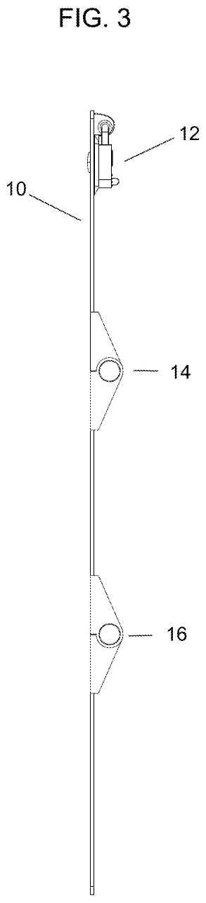

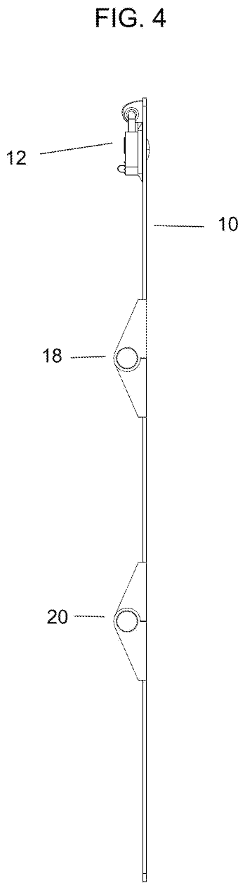

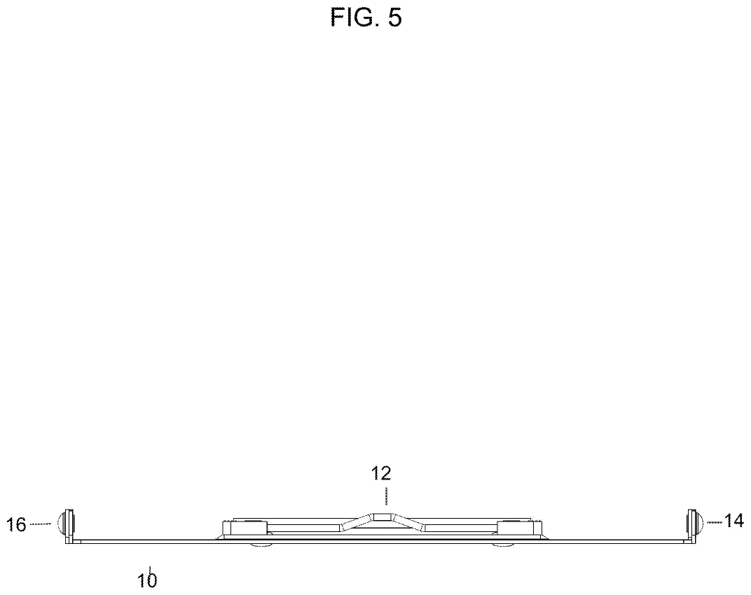

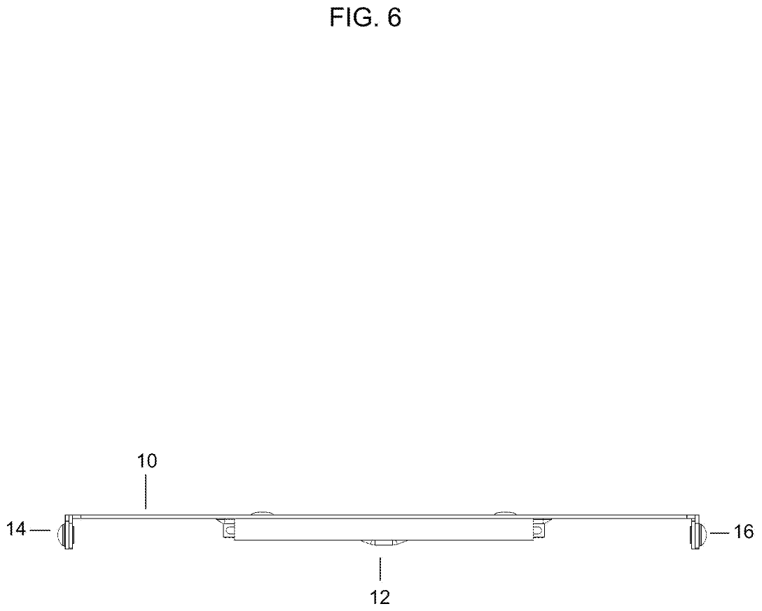

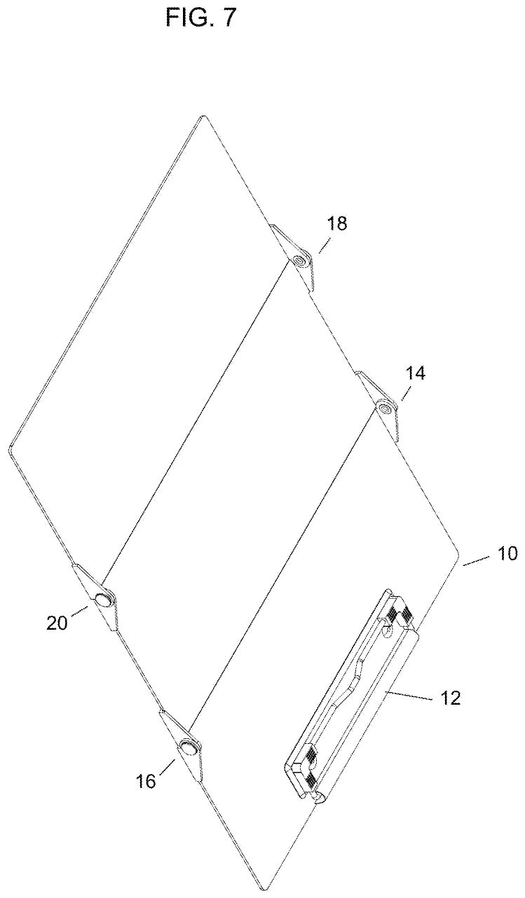

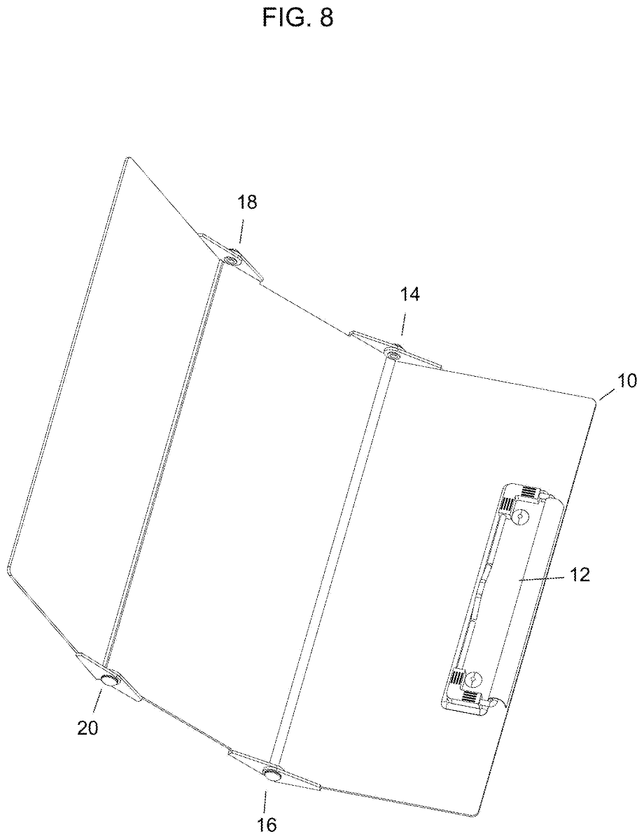

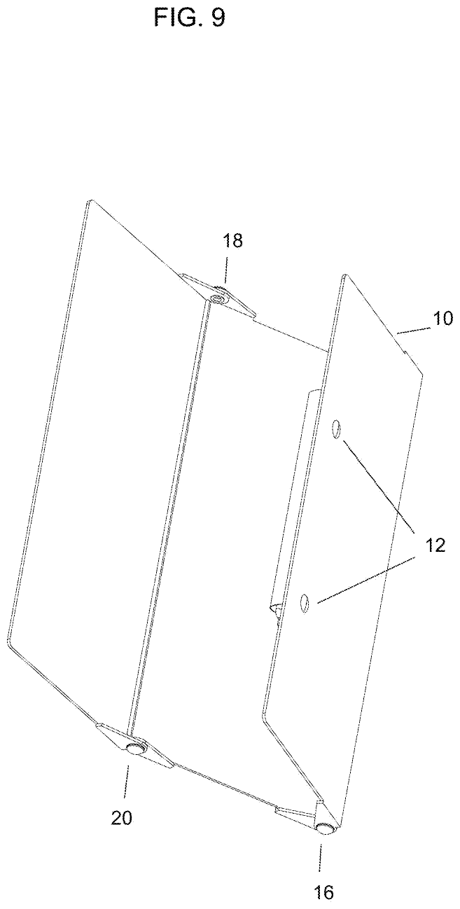

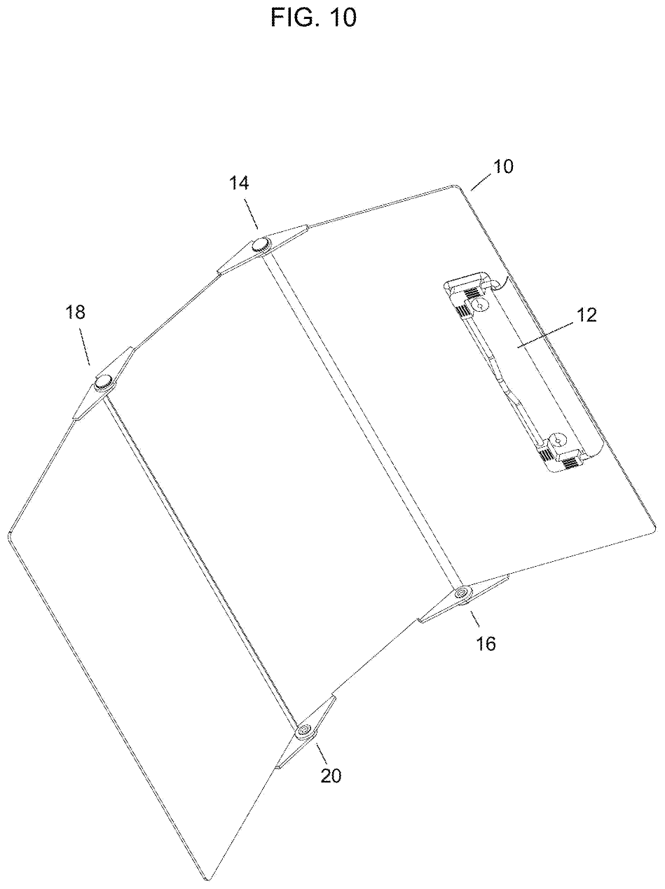

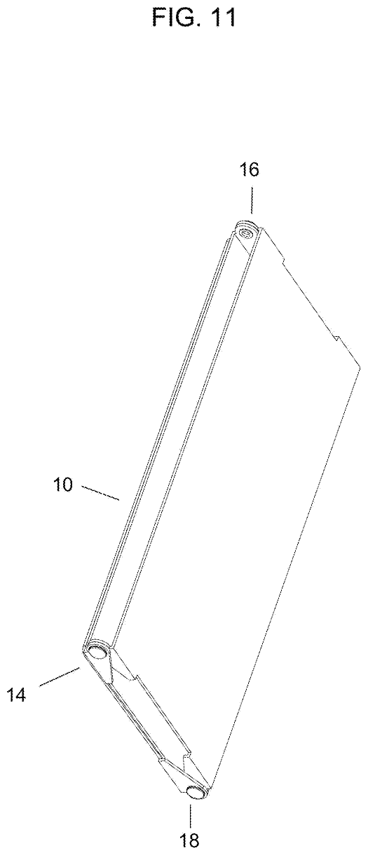

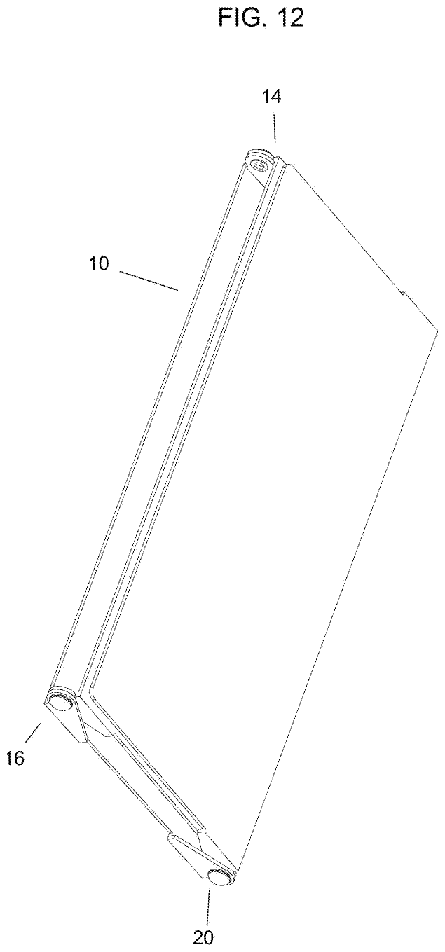

Referring now to FIGS. 1-12, the foldable clipboard 10 includes a clip 12, as well as a first folding panel, a second panel, and a third folding panel. The first folding panel, the second folding panel, and the third folding panel are planar. Further, each panel is also, for example, but not by way of limitation, substantially rectangular. “Substantially rectangular” as used herein, means that at least eighty percent of the shape is rectangular, but the shape may include minor variations, such as flanges, and the like.

The first folding panel includes the clip 12, and the first folding panel is defined by an upper edge and a spaced-apart lower edge, a first side edge spaced-apart from a second side edge, an upper surface and a lower surface.

The second panel includes an upper edge and a spaced-apart lower edge, and a first side edge spaced-apart from a second a side edge. The second panel includes an upper surface, and a lower surface. The third folding panel and the first folding panel fold over the second panel, respectively.

The third folding panel also includes an upper edge, a spaced-apart lower edge, a first side edge and a second side edge. The third folding panel also includes an upper surface and a lower surface.

The clip 12 is positioned desirably and for example, but not by way of limitation, on the upper surface of the first panel near the upper edge thereof, and includes a mechanism, i.e, a clip, to hold writing material (not shown) to the foldable clipboard. While one type of clip is illustrated and described in detail herein, it will be appreciated that any low profile clip which holds writing material to the foldable clipboard may be used. For example, the present clip may include a bracket and a pair of connectors which connect the bracket to the foldable clipboard. The bracket desirably includes a spring-loaded clip in the form of a handle which is urged toward the foldable clipboard. When the handle is raised, writing material may be positioned on the foldable clipboard and when the handle is released, the handle is urged toward the foldable clipboard to hold the writing material in a desired position.

The clip 12 and any part(s) thereof may be formed from metal and/or plastic. The clip 12 illustrated herein is commercially available. The clip may be connected to the foldable clipboard via welding, adhesives, connectors (as shown herein) or by any other manner known in the art.

A pair of first 14 and second 16 upper hinges and a pair of first 18 and second 20 lower hinges connect the first folding panel, the second panel, and the third folding panel together. First 14 and second 16 upper hinges, include outer leg brackets, and inner leg brackets, respectively.

In the first upper hinge 14, the outer leg bracket is pivotally connected to the inner leg bracket via a pin. The outer leg bracket is also connected to the first side edge of the first folding panel near the lower edge thereof. The inner leg bracket is connected to the first side edge of the second panel near the upper edge thereof.

Similarly, in the second upper hinge 16, the outer leg bracket is connected to the inner leg bracket via a pin. The outer leg bracket is also connected to the second side edge of the first folding panel near the lower edge thereof. The inner leg bracket is connected to the second side edge of the second panel near the upper edge thereof.

First 18 and second 20 lower hinges, include outer leg brackets, and inner leg brackets, respectively. In the first lower hinge 18, the outer leg bracket is pivotally connected to the inner leg bracket by a pin. The outer leg bracket is also connected to the first side edge of the second panel near the lower edge thereof. The inner leg bracket is connected to the first side edge of the third folding panel near the upper edge thereof.

And in the second lower hinge 20, the outer leg bracket is pivotally connected to the inner leg bracket by a pin. The outer leg bracket is also connected to the second side edge of the second panel near the lower edge thereof. The inner leg bracket is connected to the second side edge of the third folding panel near the upper edge thereof.

Each hinge 14, 16, 18, and 20 is a type of knife hinge and may be formed, for example, but not by way of limitation, from metal or plastic. The hinges 14, 16, 18, and 20 may be integrally formed with each panels as shown and described herein, and the pivot pin added to each later. Alternatively, each hinge 14, 16, 18, and 20 may be connected to panels as shown and described in detail herein by welding, adhering, connecting via connectors, and all other forms of connection known in the art. Knife hinges are available commercially. Varying a position of hinges on a surface of a panel rather than an edge of a panel is also enabled herein, as is a variation of size of any hinge herein.

Each hinge 14, 16, 18, and 20 respectively is formed to permit each outer leg bracket thereof, respectively, to overlap each inner leg bracket, respectively. Each location and each connections of each hinge 14, 16, 18, and 20 are configured to enhance the ability of the foldable clipboard to fold as shown and described herein.

Each inner leg bracket respectively, and each outer leg bracket, respectively, of each hinge respectively, is connected to the foldable clipboard along an inner surface of each outer leg bracket respectively, and each inner leg bracket respectively, of each respective hinge. Each outer leg brackets 70, of hinges, respectively, may include, or be position upon a small flange (formed on each side edge of the first folding panel and the third folding panel) to permit the connection of the outer leg brackets to their respective panels, namely, the first folding panel (outer leg brackets) and the third folding panel (outer leg brackets), so that each outer leg bracket can overlap its respective inner leg bracket.

In a method of use, the position of outer leg brackets and inner leg brackets relative to the first folding panel and the third folding panel permit the third folding panel and the first folding panel to fold over the second panel, and the third panel, respectively. That is, the outer leg brackets, respectively, of the first and second lower hinges 18 and 20, respectively, pivotably move to overlap the inner leg brackets respectively, of the first and second lower hinges 18 and 20, respectively, to permit the third folding panel to fold and overlap the second panel. And the ratter leg brackets, respectively, of the first and second upper hinges, respectively, pivot to overlap the inner leg brackets, respectively, of the first and second upper hinges 14 and 16, respectively, to permit the first folding panel to fold and overlap the third folding panel.

It will be understood that the panels of the foldable clipboard cooperate to form a single flat, planar surface which is rigid and suitable for securing documents and providing a writing surface to hold writing material (not shown) thereupon. In this configuration, a person can easily hold and write on the planar surface thereon. This planar position is deemed the planar expanded position. When in the planar extended position, it will be appreciated that the lower edge of first folding panel abuts the upper edge of the second panel. And the upper edge of the third folding panel abuts the lower edge of the second panel, to form the planar expanded position.

When the foldable clipboard is moved into the folded position, the foldable clipboard naturally hides any writing materials it is holding, thus helping maintain confidentiality when it is desired, while also protecting the writing material from damage. And, when in the folded position, the foldable clipboard may be positioned in a pocket, a purse, and the like.

The foldable clipboard may be constructed of any suitable rigid material, such as cardboard, metal, plastic, and combinations thereof. In particular, but not by way of limitations, aluminum provides a very strong, lightweight material that is very durable. Alternatively, plastic also provides a strong and lightweight material that is relatively inexpensive to manufacture. The foldable clipboard may have any desired dimensions which will hold a standard writing material, such as, for example, an 8.5 inch by 11 inch piece of paper, when the foldable clipboard is in the expanded position. However, it must be noted that the foldable clipboard should be sized appropriately to accommodate an 8.5 inch by 11 inch writing material, but should not expand significantly therebeyond. For example, but not by way of limitation, the foldable clipboard may have a length 100 of 12 inches and a width 102 of 9 inches. The depth 104 or thickness of the foldable clipboard may range from 0.5 millimeter to 5 millimeters. It will be understood that other lengths, depths, and widths of the foldable clipboard are possible, so long as the foldable clipboard operates as shown and described in detail herein, and includes the advantages shown and described herein.

Each panel of the foldable clipboard, desirably is generally rectangular, and may be configured to be substantially rectangular in shape. Alternatively, one or more panels may include alternative dimensions. For example, first folding panel and third folding panel includes small flanges on each side edge, respectively, thereof. The first folding panel may have rounded outer corners and the third folding panel may also have rounded comers. Each rounded corner may have, for example, but not by way of limitation, a slope that is about a 30 degree slope. The rounded edges are advantageous in allowing the foldable clipboard to smoothly store in a pocket or other enclosure.

When the foldable clipboard is moved into the folded position, a first space opens between the third folding panel and the second panel, and a second space opens between the second panel and the first folding panel. The first and second space, respectively, and the hinges, permit the spacing of both the overlapped third folding panel and the overlapped first folding panel, such that the third folding panel may have about a 0 degrees angle relative to the second panel when in the folded position and therefore is substantially parallel thereto, and the first folding panel may have about a 0 degree angle relative to the third folding panel, and similarly will be about or substantially parallel thereto. However, it will be understood that this desired about 0 degree angle may vary somewhat when a large amount of writing material is held on the foldable clipboard. Therefore, as used herein, “about a 0 degree” angle or “substantially a 0 degree” angle, or “substantially parallel” or “about parallel”, means within a range of between 0 degrees and 5 degrees of an angle or alignment, such as a “parallel” alignment.

When the foldable clip board is in the planar expanded position, the first folding panel, the second folding panel, and the third folding panel cooperate together with the hinges to form a first stop which is formed between the lower edge of the first folding panel and the upper edge of the second panel which abut each other in the expanded position, to assist in holding the first folding panel and the second holding panel in the planar expanded position. Similarly, a second stop is formed between the lower edge of the second panel and the upper edge of the third folding panel which abut each other in the expanded position, to assist in holding the second panel and the third folding panel in the planar expanded position.

While the clip 12 is positioned on an upper surface of the first folding panel, it will be understood that the clip 12 is excluded from the consideration of the planar expanded position, and the clip 12 is desirably a low profile clip as illustrated, or could be formed partially or totally within the first panel to conform to more closely conform to the planar formation of the foldable clipboard.

Although the invention has been shown and described concerning a certain preferred embodiment or embodiments, certain equivalent alterations and modifications will occur to others skilled in the art upon the reading and understanding of this specification and the annexed drawings. In particular regard to the various functions performed by the above-described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed concerning only one of several embodiments, such feature may be combined with one or more features of the other embodiments as may be desired and advantageous for any given or particular application.

What is claimed is:

1. A foldable clipboard, comprising:
a first folding panel, a second panel, and a third folding panel configured to form a single planar surface when positioned in an expanded position, such that a second edge of the first folding panel abuts a first edge of the second panel and a second edge of the second panel abuts a first edge of the third folding panel;
a first pair of hinges; and
a second pair of hinges, wherein:
each hinge of the first pair of hinges and the second pair of hinges includes an outer leg bracket and an inner leg bracket that are pivotally connected together;
the outer leg brackets and the inner leg brackets are configured to rotate towards the front surface of the foldable clipboard; and
wherein when the foldable clipboard is moved into a folded position, the inner side of each outer bracket of both the first pair of hinges and the second pair of hinges moves over at least a portion of each inner side of each inner leg bracket of both the first pair of hinges and the second pair of hinges.

2. The foldable clipboard of claim 1, wherein the foldable clipboard folds transversely relative to an axial alignment of the foldable clipboard when in the expanded position.

3. The foldable clipboard of claim 1, wherein when in the folded position, the first folding panel is substantially parallel with the second folding panel, which is in a position in a range of about 0 to 5 degrees relative to the second folding panel.

4. The foldable clipboard of claim 3, wherein when in the folded position, the third folding panel is substantially parallel to the second panel.

5. The foldable clipboard of claim 1, further comprising a clip.

6. The foldable clipboard of claim 5, wherein the clip is a spring-loaded clip.

7. The foldable clipboard of claim 6, wherein the clip includes a mounting bracket connected to a surface of the foldable clipboard.

8. The foldable clipboard of claim 7, wherein an upper edge of the first folding panel and a lower edge of the third folding panel are parallel relative to each other.

9. The foldable clipboard of claim 1, wherein a pair of ends of the first folding panel are each rounded, and wherein a pair of ends of the third folding panel are each rounded.

10. The foldable clipboard of claim 1, wherein the first folding panel, the second panel, and the third folding panel are constructed from at least one of metal, plastic, and cardboard.
